(19) United States
(12) Patent Application Publication
(10) Pub. No.: US 2014/0341254 A1
(43) Pub. Date: Nov. 20, 2014

(54) COLD SPOT MEAT PROBE

(71) Applicant: W.C. Bradley Co., Columbus, GA (US)

(72) Inventors: JOSE RAUL MENDEZ, Columbus, GA (US); ANDREW WOLF KAHLER, Fortson, GA (US); ALEX GAFFORD, Midland, GA (US)

(73) Assignee: W.C. Bradley Co., Columbus, GA (US)

(21) Appl. No.: 14/277,444

(22) Filed: May 14, 2014

Related U.S. Application Data
(60) Provisional application No. 61/823,118, filed on May 14, 2013.

(51) Int. Cl. G01K 13/00

(52) U.S. Cl. CPC G01K 13/00; G01K 2207/06
USPC 374/137

(57) ABSTRACT

A food temperature probe having a skewer for inserting into a food product, a plurality of temperature sensors within the skewer that detect a temperature at each temperature sensor location of the food product, and a single connector communicatively coupled to the plurality of temperature sensors.

### CROSS-REFERENCE TO RELATED CASES

This application claims the benefit of U.S. provisional patent application Ser. No. 61/823,118, filed on May 14, 2013, and incorporates such provisional application by reference into this disclosure as if fully set out at this point.

### FIELD OF THE INVENTION

The present invention relates generally to the field of meat preparation and, more particularly, to determining the internal temperature of a portion of meat.

### BACKGROUND OF THE INVENTION

Determining whether the internal temperature of a portion of meat being prepared for consumption is of importance for many reasons. In addition to matters of safety, the temperature to which a portion of meat is heated may vary its flavor profile. Tenderness and the affect that various spices and additives may have can also be influenced heavily by cooking temperature.

In the past, a simple temperature probe has been inserted into the meat at some point during the cooking procedure. With previous solutions, a user must attempt to locate the thickest portion of the meat in order to attempt to gauge the coldest location. The external temperature of the meat will normally be much greater than the internal temperature, but it is the temperature of the coldest portion of the meat that must be monitored. Generally, the entire portion of meat must be heated to a minimum safe temperature before the meat is fit for consumption. However, determining that the probe is reading the temperature of the coldest location can be problematic. Cuts of meat are often irregularly shaped, and may not have heated as evenly as expected. Even if the probe is accurately placed in the center of the thickest portion of the meat, this may not be the coldest location depending upon how the meat has been cooked and positioned relative to the heat source.

What is needed is a system and method for addressing the above and related issues.

### SUMMARY OF THE INVENTION

The invention of the present disclosure, in one aspect thereof, comprises a food temperature probe having a skewer for inserting into a food product, a plurality of temperature sensors within the skewer that detect a temperature at each temperature sensor location of the food product, and a single connector communicatively coupled to the plurality of temperature sensors.

In some embodiments, the single connector transfers temperature data to a display device. The plurality of temperature sensors may comprise at least three temperature sensors spaced equidistantly within the skewer. In other embodiments, the plurality of temperature sensors comprises at least five temperature sensors spaced equidistantly within the skewer. At least one of the plurality of temperature sensors may be proximate a tip of the skewer. The skewer may include an angled portion.

The connector may be a co-axial connector or a universal serial bus connector. A braided wire covering may surround a plurality of communicative couplings interposing the plurality of temperature sensors and the connector.

The invention of the present disclosure, in another aspect thereof comprises a food temperature probe having a rigid skewer, and a plurality of temperature sensors within the skewer, the plurality of temperature sensors being spaced equidistantly apart within the skewer and a first of the plurality of skewers being located proximate a tip of the skewer. A plurality of communicative links is coupled to the plurality of temperature sensors, and a single data connector is coupled to the plurality of communicative links. The single data connector provides data from the plurality of temperature sensors corresponding to a temperature sensed at the location of each of the plurality of temperature sensors within the skewer.

A braided metal cover may surround the plurality of communicative links. The data connector may be a coaxial connector or a universal serial bus connector. In some embodiments, the skewer may be curved.

The invention of the present disclosure, in another aspect thereof, comprises a system for sensing temperatures at multiple locations within a food product. The system includes a rigid skewer, a plurality of temperature sensors within the skewer, a plurality of communicative links coupled to the plurality of temperature sensors, and a single data connector coupled to the plurality of communicative links that provides data from the plurality of temperature sensors corresponding to a temperature sensed at the location of each of the plurality of temperature sensors within the skewer. The system includes a display device having an interface with the single data connector and receiving and displaying temperature data from the plurality of temperature sensors.

The display device may receive temperature data from the plurality of temperature sensors as voltages and displays the temperature data visually. The system may include a microcontroller programmed to determine at least an average of temperature values from the plurality of temperature probes and a lowest of the temperature values from the plurality of temperature probes. The display device may include a user input for selecting data to display on the display device. A power supply may power the plurality of temperature sensors via the single data connector. A braided metal cover may surround the plurality of communicative links while interposing the skewer and the single data connector.

### BRIEF DESCRIPTION OF THE DRAWINGS

FIG. 1 is a cross sectional view of a portion of poultry, including representative internal bone structure, being probed for temperature.

FIG. 2 is a cross sectional view of a portion of poultry, including representative internal bone structure, with a probe according to the present disclosure inserted therein.

FIGS. 3(A), 3(B), and 3(C) illustrate temperature information display screen features according to aspects of the present disclosure.

FIG. 4 illustrates a side cutaway view of a testing procedure for a temperature probe according to aspects of the present disclosure.

FIG. 5 is a block diagram of an exemplary control and display device.

FIG. 6 is a plan view of an exemplary control and display device.

FIG. 7 is a schematic view of a temperature probe according to the present disclosure.

FIG. 8 is a schematic view of another temperature probe according to the present disclosure.

FIG. 9 is a simplified schematic of the internal connections of a temperature probe according to aspects of the present disclosure.

### DETAILED DESCRIPTION OF THE PREFERRED EMBODIMENTS

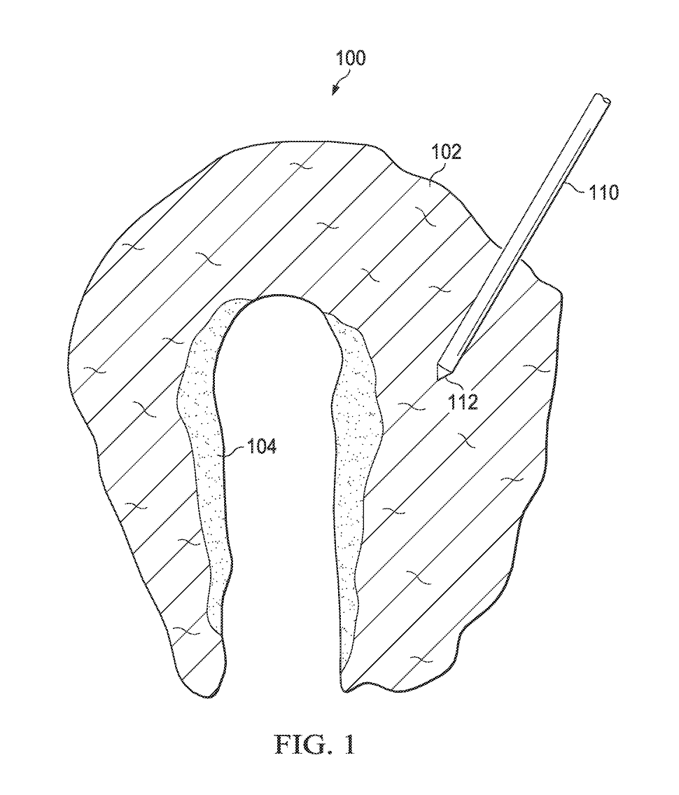

Referring now to FIG. 1, a cross sectional view of a portion of poultry 100, including meat portion 102 and representative internal bone structure 104, being probed for temperature is shown. Determining the temperature of meat being cooked in a cooking device such as a gas, electric, or charcoal grill, roaster, or oven often involves the use of a temperature probe 110 which may comprise a hollow metal rod with a pointed end, in which is embedded a temperature transducer device 112 for converting heat into an electrical signal. This transducer is typically placed at or near the end of the rod, and there is a single such device in the probe 110. The transducer 112 may be a thermocouple (TC), resistance temperature detector (RTD), or thermistor. If a thermistor is utilized, it may be of a negative temperature coefficient (NTC) type.

One limitation with prior temperature probes is that the temperature sensed and reported by the probe is at one, and only one, point on the probe. This single point will typically be near the far end, as shown in FIG. 1. A great deal of skill is required in placing the probe to exactly the right position to obtain the section of the meat that cooks the slowest and therefore is the last to reach a safe temperature for human consumption (e.g., as stated by USDA guidelines). Often a 5° to 10° F. variation in temperature will be found within a single portion of meat depending on where the probe is placed. This is particularly problematic in poultry with its complex geometry and bone structure. It will be apparent to anyone familiar with the art that the piece of poultry meat will have various temperatures at various points due to the varying thickness and the presence of bone, which has different heat transfer characteristics than meat. The relative heating of various portions of the meat may also be affected by the position and time the meat has been exposed to heat. The foregoing illustrates that a single point measurement may give a misleading picture of the degree of doneness, as it is not immediately clear to the user whether or not the single temperature sensitive portion of the probe has been placed correctly at the coldest location of the meat.

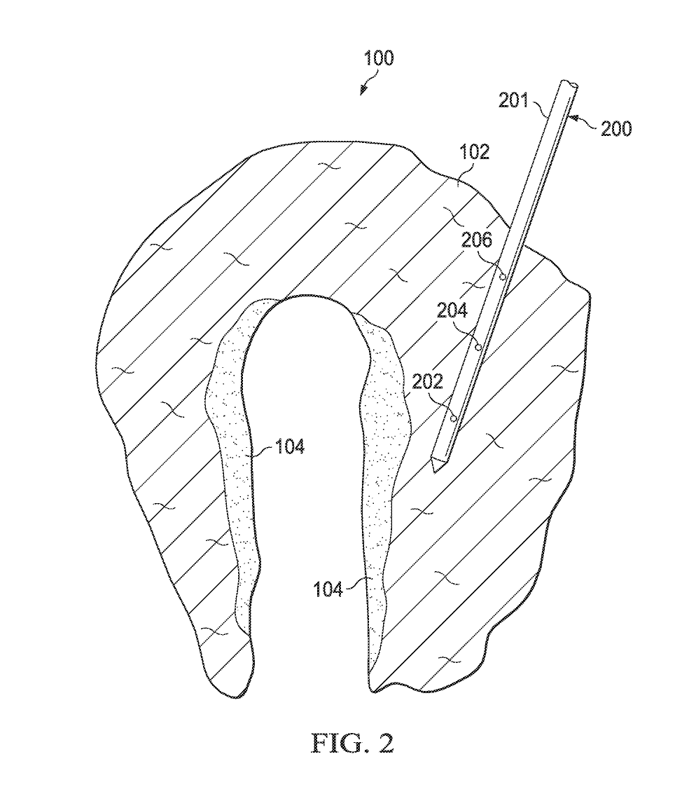

FIG. 2 is a cross sectional view of a portion of poultry 100, including meat portion 102 and representative internal bone structure 104, with a probe 200 according to the present disclosure inserted therein. Although a portion of poultry 100 is used for illustrative purposes, it is understood that the embodiments of the present disclosure may be useful in measuring the internal temperature of any kind of food product. According to various embodiments of the present disclosure, a rigid skewer 201 acts as an insertable portion of the probe 200 and contains a series of multiple temperature measuring devices or transducers (e.g., of the type described above), internally along its length. In the present embodiment, three temperature measurement or transducer devices 202, 204, 206 are shown, but more or fewer could be provided depending upon the embodiment. Each transducer device 202, 204, 206 may be wired to report the temperature at that point to as display and control device (as discussed further below).

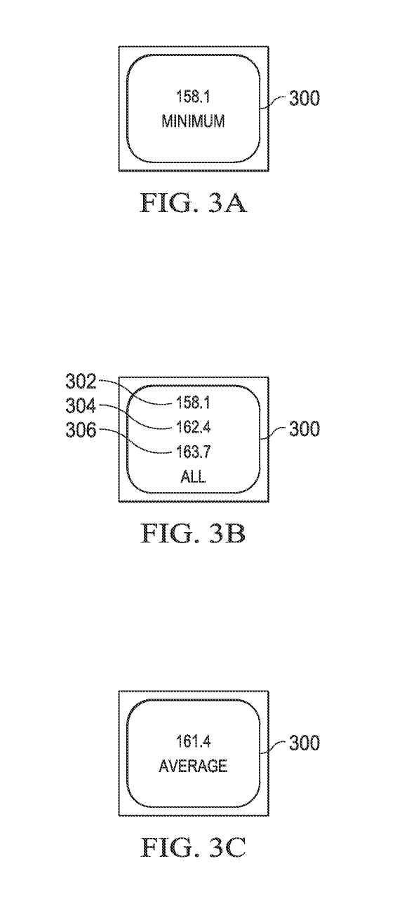

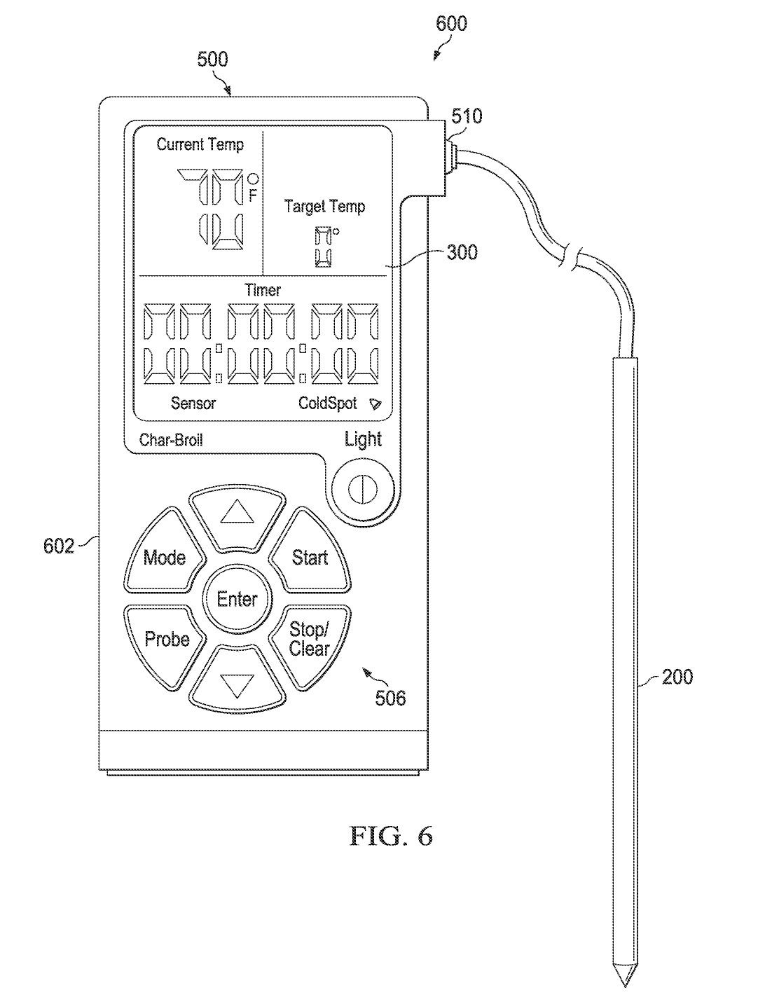

FIGS. 3(A), 3(B), and 3(C) illustrate a number of options for displaying data obtained from the probe 200 and the plurality of temperature sensors 202, 204, 206 on a single display screen 300. A number of options may be presented the display 300 and the display 300 may comprise a portion of a control and display device as explained further below (see, e.g., FIG. 6). As is shown in FIG. 3(A), the display 300 may be configured to display only the lowest temperature sensed by the probe 200. As shown in FIG. 3(B) all temperatures may be displayed sequentially. Here temperatures 302, 304, 306 correspond to temperatures detected by transducers 202, 204, 206, respectively. FIG. 3(B) illustrates an option to display the average of temperatures sensed by all of the sensors 202, 204, 206. The configurations shown in FIGS. 3(A), 3(B), and 3(C) are exemplary only and other display modes are possible. In one embodiment, the display device 300 is user selectable to display the temperature of the tip of the skewer 201 as determined by the temperature transducer 202. In other words, the temperature corresponding to the most distal temperature transducer in the probe 200. Multiple data modes may also be display concurrently. The display 300 may be user selectable allowing the user to choose the data to display.

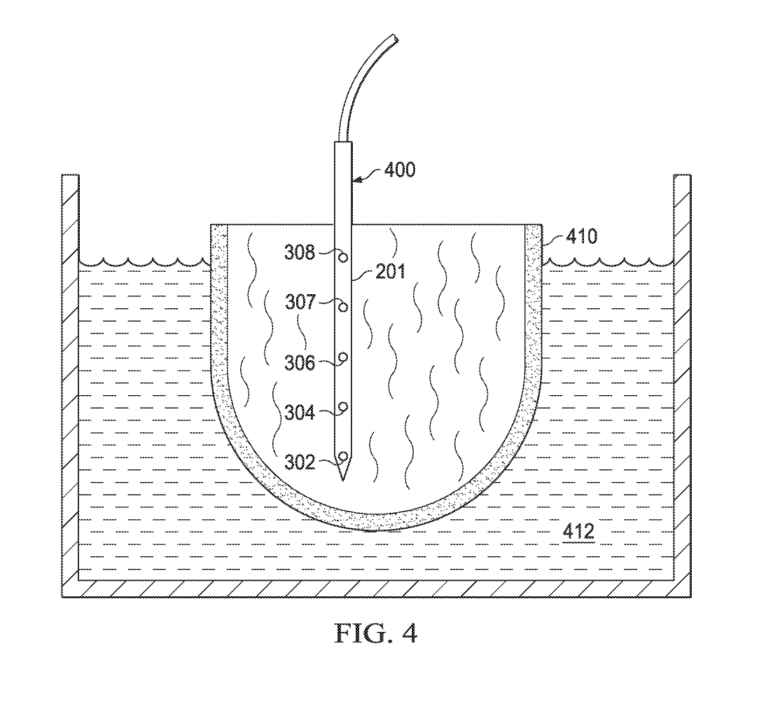

Referring now to FIG. 4, a side cutaway view of a testing procedure for a temperature probe 400 according to aspects of the present disclosure is illustrated. The probe 400 was constructed according to the present disclosure. The probe comprised a stainless steel tube 5 mm in diameter serving as the skewer 201. In the present embodiment five transducers (302, 304, 306, 307, 308) were placed about 22.5 mm apart inside the skewer 201. The skewer 201 was placed in a Chinese watermelon 410, which was then placed in a 100° C. oil bath 412. The results from the temperature probe at the start, at ten minutes, and at 30 minutes are summarized in Table 1 below in degrees Celsius. The table illustrates that multiple and varying temperatures can be sensed by multiple transducers within the same probe. It also illustrates that temperature changes over time can accurately be tracked with the device 400.

TABLE 1

| Time: | 0 | 10 min | 30 min |
|---|---|---|---|
| Sensor 302 | 29.5 | 51.5 | 95.0 |
| Sensor 304 | 29.6 | 45.2 | 90.9 |
| Sensor 306 | 29.4 | 40.2 | 87.5 |
| Sensor 307 | 29.3 | 38.4 | 85.2 |
| Sensor 308 | 29.5 | 34.4 | 81.5 |

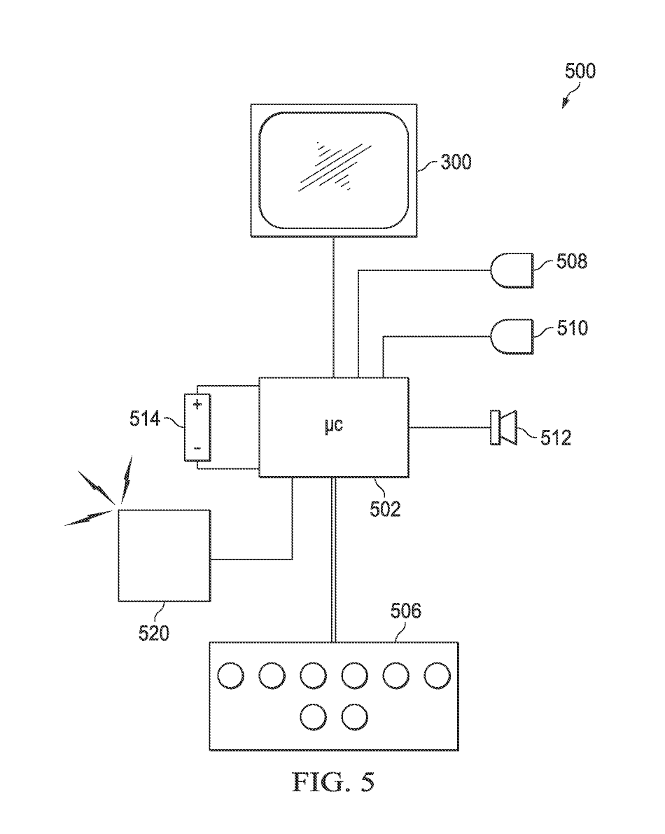

Referring now to FIG. 5, a block diagram of an exemplary control and display device is shown. The device 500 may include a controller 502. The controller 502 may comprise a microcontroller, FPGA, ASIC, or other device capable of performing the requisite functions associated with reading the temperature probe, determining high and low readings, averages, and the like. In some cases, the controller 502 may comprise a system-on-a-chip device that contains all the necessary input/output ports and controllers as well as A/D and/or D/A converters. A display device 300 may be attached. In various embodiments the display device 300 may comprise a segmented display based on LED or LCD technology. User inputs devices in the form of knobs or buttons 506 may also be communicatively coupled to the controller 502.

In some embodiments, the temperature probe (e.g., 200, 400) connects to the controller 502 with a single interface. However, multiple types of connectors may be provided. For example, a USB input 508 may be provided, in addition to a coaxial input 510. In some embodiments, a buzzer or alarm 512 may be provided. The present embodiment draws power from an onboard power supply 514, which, in the present embodiment, is a battery.

Some embodiments provide the ability to communicate temperature data to a secondary device (not shown) such as a computer, tablet, or smart phone. The control and display device 500 may communicate such information via a wired connection, but in the present embodiment a wireless module 520 is utilized. The wireless module 520 may be packaged with the rest of the internal components of the control and display device 500 and may draw power from the onboard power supply 514. The wireless module 520 may be communicatively coupled to the microcontroller 502. In other embodiments the wireless module 520 may be integrated with the microcontroller 502 (e.g., in the case where a “system on a chip” device is employed). The wireless module may implement Bluetooth®, 802.11, or other wireless protocols to communicate with the secondary device. Various applications and programs may be implemented on the secondary device to utilize or track the temperature data received.

FIG. 6 is a plan view of an exemplary temperature probe system 600 according to the present disclosure. Various buttons 506 are provided for the user to call up various modes and readouts on the display 300. In some cases, the control and display device 500 will provide additional functionality (e.g., via the microcontroller 502). For example, a target temperature may be set by user with the controls 506. The control and display device 500 will monitor the temperatures reported by the probe 200 until the target temperature is reached. The user may then be notified by an audio or visual queue that cooking is complete.

The display and control 500 device may also house an internal power supply (e.g., a battery) or may connect to an external power supply. The physical case may be made weatherproof, waterproof, shockproof, and/or fogproof. This will allow the system 600 to be utilized in a wide variety of weather conditions and to be able to survive inadvertent exposure to rain, sun, extreme heat and other hazards.

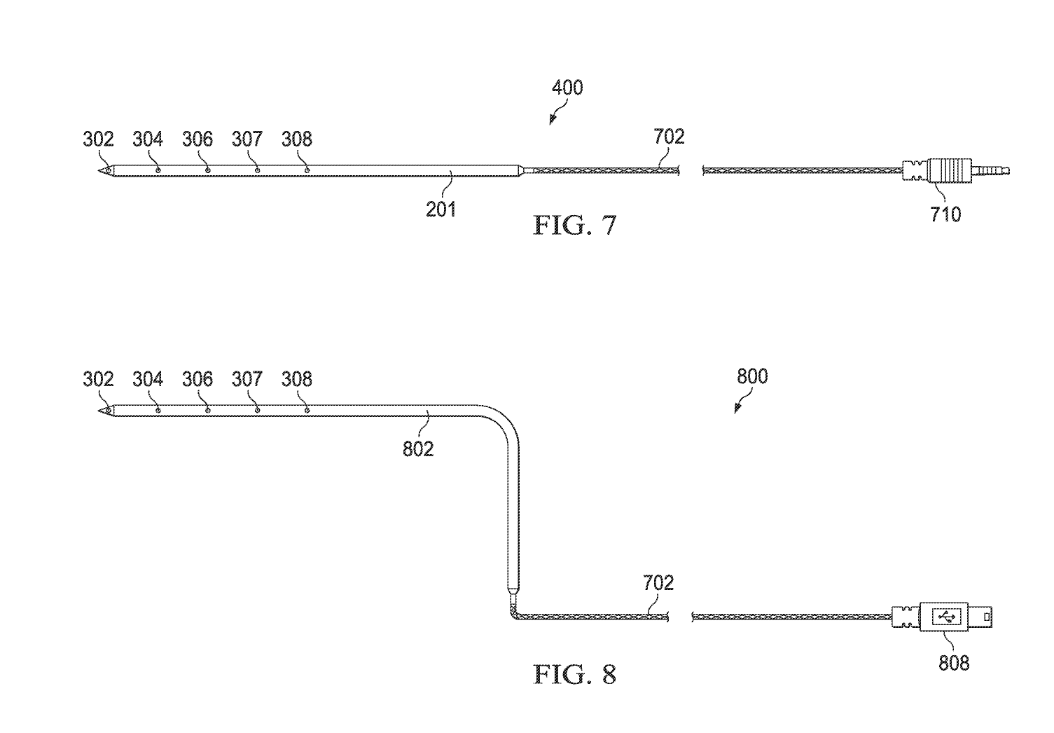

FIG. 7 is a schematic view of the temperature probe 400 according to the present disclosure. In this embodiment, five sensors are provided within a straight stainless steel skewer 201. The skewer 201 may be hollow to allow for insertion of the temperature sensors 302, 304, 306, 307, 308. The temperature sensors 302, 304, 306, 307, 308 may be spaced equidistantly apart within the skewer 201 with the most distal temperature sensor 302 being substantially at or near the tip or distal end of the skewer 201. In one embodiment, the temperature sensors 302, 304, 306, 307, 308 are placed about 22.5 mm apart. This allows a user to sense temperatures across an area of 90 mm, minimizing the criticality of exact probe placement within the food product.

The skewer 201 may be stainless steel or another suitably rigid material with good thermal conductivity to allow the sensors 302, 304, 306, 307, 308 to reliably read the temperature of the adjacent portion of food product. The total length of the skewer should be sufficient to house the temperature sensors 302, 304, 306, 307, 308 in the number and spacing of the instant embodiment while providing sufficient further length to allow the user to insert the skewer 201 adequately into the food product (e.g., ensuring the tip of the skewer 201 is at or beyond the center of the food product). A flexible braided metal wire cover 702 contains the electrical connections from the probes to the control and display device via coaxial connector 710.

FIG. 8 is a schematic view of another embodiment of a temperature probe 800 according to the present disclosure. This embodiment again provides five temperature transducers 302, 304, 306, 307, 308 along a stainless steel skewer 802. The skewer 802 is bent or has an angled portion for ease of use. It is understood that in other embodiments, the skewer 802 may be bent differently, or the portion of the skewer 802 containing the transducers may also have a curve, bend, or other shape, which may make it easier to insert through and around bone or other structure to make certain the coldest temperature is being measured.

The embodiment of FIG. 8 also protects the electrical contacts running to the transducers 302, 304, 306, 307, 308 inside a flexible braided metal wire 702. However, in the present embodiment, the interface to the display and control device is via a universal serial bus connection 808. It is understood that various other physical connections and protocols could be employed to allow the display and control device (e.g., 500) to adequately register or poll the multiple transducers within the probe (e.g., 200, 400, or 800).

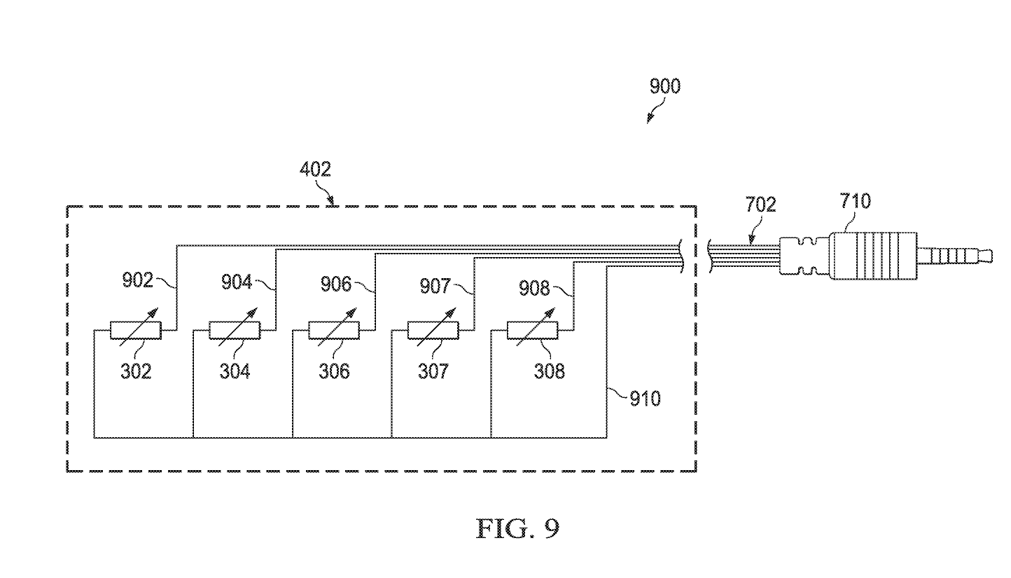

Referring now to FIG. 9 is a simplified schematic diagram 900 of the internal connections of a temperature probe 402 according to aspects of the present disclosure is shown. A single voltage or power lead 910 may be common to the plurality of temperature sensors. This may connect to the battery or other internal power supply of the associated control and display device 500. Each of the temperature sensors 302, 304, 306, 307, 308 internal to the skewer 402 may provide a voltage on an output lead 902, 904, 906, 907, 908, respectively, that varies according to the temperature of the sensor. In most instances, when being used, the temperature sensors 302, 304, 306, 307, 308 will each report a different voltage corresponding to the temperature at or near its location in the skewer 402. The microcontroller 502 may handle the necessary A/D conversion for determining temperature or a separate A/D device could be employed.

The power lead 910 and output leads 902, 904, 906, 907, 908 (as well as any other necessary ground or other leads as are known to those of skill in the art) may be bundled within the cover 702 as they travel to the connector 710. The coaxial connector 710 provides a series of electrically isolated contacts on its output that correspond to the leads 902, 904, 906, 907, 908, 910 and are used to send and receive power and signal voltages by the control and display device 500.

Although various embodiments of the present disclosure have been illustrated and described with regard to being utilized to determine the temperature of a portion of meat, it is understood that the various embodiments of the present disclosure may be used to gather temperature information for any food product. Meatloaf, casseroles, and other dishes often need to be cooked to a minimum temperature for safety, flavor, or other reasons. Embodiments of the present disclosure are useful with these and many other food products.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the invention as defined by the claims.

What is claimed is:

1. A food temperature probe, comprising:
a skewer for inserting into a food product;
a plurality of temperature sensors within the skewer that detect a temperature at each temperature sensor location of the food product; and
a single connector communicatively coupled to the plurality of temperature sensors.

2. The food temperature probe of claim 1, wherein the single connector transfers temperature data to a display device.

3. The food temperature probe of claim 1, wherein the plurality of temperature sensors comprises at least three temperature sensors spaced equidistantly within the skewer.

4. The food temperature probe of claim 1, wherein the plurality of temperature sensors comprises at least five temperature sensors spaced equidistantly within the skewer.

5. The food temperature probe of claim 1, wherein at least one of the plurality of temperature sensors is proximate a tip of the skewer.

6. The food temperature probe of claim 1, further comprising a braided wire covering surrounding a plurality of communicative couplings interposing the plurality of temperature sensors and the connector.

7. The food temperature probe of claim 1, wherein the connector is a co-axial connector.

8. The food temperature probe of claim 1, wherein the connector is a universal serial bus connector.

9. The food temperature probe of claim 1, wherein the skewer comprises an angled portion.

10. A food temperature probe, comprising:
a rigid skewer;
a plurality of temperature sensors within the skewer, the plurality of skewers being spaced equidistantly apart within the skewer and a first of the plurality of temperature sensors being located proximate a tip of the skewer;
a plurality of communicative links coupled to the plurality of temperature sensors; and
a single data connector coupled to the plurality of communicative links that provides data from the plurality of temperature sensors corresponding to a temperature sensed at the location of each of the plurality of temperature sensors within the skewer.

11. The food temperature probe of claim 10, further comprising a braided metal cover surrounding the plurality of communicative links.

12. The food temperature probe of claim 10, wherein the data connector comprises a coaxial connector.

13. The food temperature probe of claim 10, wherein the data connector comprises a universal serial bus connector.

14. The food temperature probe of claim 10, wherein the skewer is curved.

15. A system for sensing temperatures at multiple locations within a food product, comprising:
a rigid skewer;
a plurality of temperature sensors within the skewer, a plurality of communicative links coupled to the plurality of temperature sensors;
a single data connector coupled to the plurality of communicative links that provides data from the plurality of temperature sensors corresponding to a temperature sensed at the location of each of the plurality of temperature sensors within the skewer; and
a display device having an interface with the single data connector and receiving and displaying temperature data from the plurality of temperature sensors.

16. The system of claim 15, wherein the display device receives temperature data from the plurality of temperature sensors as voltages and displays the temperature data visually.

17. The system of claim 16, further comprising a microcontroller programmed to determine at least an average of temperature values from the plurality of temperature probes and a lowest of the temperature values from the plurality of temperature probes.

18. The system of claim 17, wherein the display device comprises a user input for selecting data to display on the display device.

19. The system of claim 15, further comprising a power supply that powers the plurality of temperature sensors via the single data connector.

20. The system of claim 15, further comprising a braided metal cover surrounding the plurality of communicative links and interposing the skewer and the single data connector.
